(19) United States
(12) Patent Application Publication
(10) Pub. No.: US 2004/0228460 A1
(43) Pub. Date: Nov. 18, 2004

(54) Portable communications devices providing selective inhibition of functionalities and related control devices and methods

(76) Inventor: Cherif Keramane, Morrisville, NC (US)

Correspondence Address: MYERS BIGEL SIBLEY & SAJOVEC, PO BOX 37428, RALEIGH, NC, 27627, US

(21) Appl. No.: 10/439,099

(22) Filed: May 15, 2003

(51) Int. Cl. H04M 11/00; H04B 1/00

(52) U.S. Cl. 379/110.01; 379/90.01

(57) ABSTRACT

A portable communications device can include a transceiver configured to receive wireless communications, and a controller coupled to the transceiver. More particularly, the controller can be configured to process communications transmitted and received by the transceiver, and the controller can be configured to provide a plurality of functionalities of the portable communications device. In addition, the controller can be configured to selectively inhibit operation of at least one of the plurality of functionalities while maintaining operation of at least another of the plurality of functionalities responsive to an inhibit communication received wirelessly at the transceiver. Related control devices and methods are also discussed.

### FIELD OF THE INVENTION

The present invention relates to portable communications devices, and more particularly to portable communications devices including multiple functionalities and related methods.

### BACKGROUND

Increasing functionality is being provided by portable communications devices. A portable communications device, for example, may combine functionalities of a plurality of a personal digital assistant (PDA), a radiotelephone, an address book, a calculator, a calendar, a digital game, a digital camera, a digital audio recorder, a digital video recorder, an e-mail transmitter/receiver, an internet browser, an audio player (such as an MP3 player), a digital video player, a pager, a word processor, a spreadsheet, a digital data transmitter, and/or a digital image viewer.

Increased functionality on a single device, however, may have a drawback that all use of the device may be prohibited in environments where one of the functionalities is prohibited. If radiotelephone communications are prohibited for safety reasons (such as on an airplane or in a hospital), for example, a blanket prohibition of use of the portable communications device including a radiotelephone may result in loss of use of other non-threatening functionalities of the portable communications device as well.

More particularly, functionalities including radio transmissions may be prohibited in environments where radio transmissions may interfere with operation of life critical electronic devices such as in a hospital or on an airplane. Certain functionalities such as radiotelephone communications may also be prohibited where silence is desired (such as in a theater). In addition, functionalities including data transmission and/or recording may be prohibited for security reasons (such as in a sensitive military area or in an embassy) or for commercial reasons (such as at a museum, a sporting event, a concert, or a theatrical performance where unauthorized image, video, and/or audio reproductions are prohibited).

### SUMMARY

According to embodiments of the present invention, a portable communications device may include a transceiver configured to receive wireless communications, and a controller coupled to the transceiver. The controller may be configured to process communications transmitted and received by the transceiver, and the controller may be configured to provide a plurality of functionalities of the portable communications device. In addition, the controller may be configured to selectively inhibit operation of at least one of the plurality of functionalities while maintaining operation of at least another of the plurality of functionalities responsive to an inhibit communication received wirelessly at the transceiver.

More particularly, the controller may be configured to provide at least two of a radiotelephone functionality, an address book functionality, a calculator functionality, a calendar functionality, a digital camera functionality, a digital game functionality, a digital audio recorder functionality, a digital video recorder functionality, a digital audio player functionality, a digital video player functionality, a pager functionality, a word processor functionality, a spreadsheet functionality, an internet browser functionality, an e-mail transmitter functionality, an e-mail receiver functionality, a digital data transmitter functionality, and/or a digital image viewer functionality. For example, at least one of a radiotelephone functionality, a digital camera functionality, a digital audio recorder functionality, a digital video recorder functionality, an e-mail transmitter functionality, and/or an internet browser functionality may be inhibited responsive to the inhibit communication while operation of at least another of the functionalities is maintained.

In response to the inhibit communication, the controller can alternately be configured to selectively inhibit wireless transmissions while maintaining operation of at least one functionality not requiring transmission. According to other alternatives, the controller can be configured to selectively inhibit digital recording of images and/or sound while maintaining operation of at least one functionality not requiring digital recording responsive to the inhibit communication.

After selectively inhibiting operation of the at least one of the plurality of functionalities, the controller can be further configured to enable operation of the at least one of the plurality of functionalities responsive to an enable communication received wirelessly at the transceiver. For example, the controller may be further configured to enable operation of at least one of the plurality of functionalities after passage of a predetermined period of time without receiving a subsequent inhibit communication. In addition, the inhibit communication can be received wirelessly at the transceiver according to a short range data communication protocol, such as a Bluetooth data communications protocol or an IEEE 802.11 data communications protocol.

According to additional embodiments of the present invention, a local control device may include a transmitter that transmits wireless communications to portable communications devices, and a controller coupled to the transmitter. The controller can be configured to process communications transmitted from the transmitter, and the controller can be configured to generate an inhibit communication for a portable communications device providing a plurality of functionalities. More particularly, the inhibit communication may instruct the portable communications device to selectively inhibit operation of at least one of the plurality of functionalities while maintaining operation of at least another of the plurality of functionalities, and the inhibit communication can be transmitted by the transmitter.

More particularly, the plurality of functionalities of the portable communications device may include at least two of a radiotelephone functionality, an address book functionality, a calculator functionality, a calendar functionality, a digital camera functionality, a digital game functionality, a digital audio recorder functionality, a digital video recorder functionality, a digital audio player functionality, a digital video player functionality, a pager functionality, a word processor functionality, a spreadsheet functionality, an internet browser functionality, an e-mail transmitter functionality, an e-mail receiver functionality, a digital data transmitter functionality, and/or a digital image viewer functionality. For example, the inhibit communication may instruct the portable communications device to inhibit at least one of radiotelephone functionality, a digital camera functionality, a digital audio recorder functionality, a digital video recorder functionality, an e-mail transmitter functionality, and/or an internet browser functionality.

The inhibit communication may alternatively instruct the portable communications device to selectively inhibit wireless transmissions while maintaining operation of at least one functionality not requiring transmission. In other alternatives, the inhibit communication may instruct the portable communications device to selectively inhibit digital recording of images and/or sound while maintaining operation of at least one functionality not requiring digital recording.

After transmitting the inhibit communication, the controller may generate an enable communication instructing the portable communications device to enable operation of the at least one of the plurality of functionalities previously inhibited, and the enable communication may be transmitted from the transmitter. In addition, inhibit and/or enable communications may be transmitted wirelessly from the transmitter according to a short range data communication protocol, such as a Bluetooth data communications protocol or an IEEE 802.11 data communications protocol. The local control device may also include a receiver coupled to the controller wherein the receiver receives an identification communication from the portable communications device and wherein the controller generates the inhibit communication for the portable communications device responsive to receiving the identification communication from the portable communications device.

According to still additional embodiments of the present invention, methods of operating a portable communications device providing a plurality of functionalities may be provided. For example, an inhibit communication may be received wirelessly, and operation of at least one of the plurality of functionalities may be selectively inhibited while maintaining operation of at least another of the plurality of functionalities responsive to the inhibit communication. For example, the plurality of functionalities of the portable communications device may include at least two of a radiotelephone functionality, an address book functionality, a calculator functionality, a calendar functionality, a digital camera functionality, a digital game functionality, a digital audio recorder functionality, a digital video recorder functionality, a digital audio player functionality, a digital video player functionality, a pager functionality, a word processor functionality, a spreadsheet functionality, an internet browser functionality, an e-mail transmitter functionality, an e-mail receiver functionality, a digital data transmitter functionality, and/or a digital image viewer functionality.

More particularly, selectively inhibiting operation of at least one of the plurality of functionalities may include inhibiting operation of at least one of a radiotelephone functionality, a digital camera functionality, a digital audio recorder functionality, a digital video recorder functionality, an e-mail transmitter, and/or an internet browser functionality while operation of at least another of the functionalities is maintained. In an alternative, selectively inhibiting operation of at least one of the plurality of functionalities may include selectively inhibiting wireless transmissions while maintaining operation of at least one functionality not requiring wireless transmission responsive to the inhibit communication. In another alternative, selectively inhibiting operation of at least one of the plurality of functionalities may include selectively inhibiting digital recording of images and/or sound while maintaining operation of at least one functionality not requiring digital recording responsive to the inhibit communication.

After selectively inhibiting operation of the at least one of the plurality of functionalities, an enable communication may be wirelessly received, and operation of the at least one of the plurality of functionalities may be enabled responsive to receiving the enable communication. In addition, operation of the at least one of the plurality of functionalities may be enabled after selectively inhibiting operation of the at least one of the plurality of functionalities for a predetermined period of time without receiving a subsequent inhibit communication. In addition, inhibit and/or enable communications can be received wirelessly according to a short range data communication protocol, such as a Bluetooth data communications protocol or an IEEE 802.11 data communications protocol.

According to yet additional embodiments of the present invention, methods of controlling operations of portable communications devices in a local area may be provided. More particularly, an inhibit communication may be generated for a portable communications device providing a plurality of functionalities wherein the inhibit communication includes instruction for the portable communications device to selectively inhibit operation of at least one of the plurality of functionalities while maintaining operation of at least another of the plurality of functionalities. The inhibit communication can then be wirelessly transmitted to the portable communications device. More particularly, the plurality of functionalities of the portable communications device may include at least two of a radiotelephone functionality, an address book functionality, a calculator functionality, a calendar functionality, a digital camera functionality, a digital game functionality, a digital audio recorder functionality, a digital video recorder functionality, a digital audio player functionality, a digital video player functionality, a pager functionality, a word processor functionality, a spreadsheet functionality, an internet browser functionality, an e-mail transmitter functionality, an e-mail receiver functionality, a digital data transmitter functionality, and/or a digital image viewer functionality.

For example, the inhibit communication may include instruction for the portable communications device to inhibit operation of at least one of a radiotelephone functionality, a digital camera functionality, a digital audio recorder functionality, a digital video recorder functionality, an e-mail transmitter functionality, or an internet browser functionality while maintaining operation of at least another of the functionalities. In another alternative, the inhibit communication may include instruction for the portable communications device to selectively inhibit wireless transmissions while maintaining operation of at least one functionality not requiring transmission. In still another alternative, the inhibit communication may include instruction for the portable communications device to selectively inhibit digital recording of images and/or sound while maintaining operation of at least one functionality not requiring digital recording.

After transmitting the inhibit communication, an enable communication may be generated instructing the portable communications device to enable operation of the at least one of the plurality of functionalities previously inhibited, and the enable communication may be transmitted to the portable communications device. In addition, inhibit and/or enable communications can be transmitted wirelessly according to a short range data communication protocol, such as a Bluetooth data communications protocol or an IEEE 802.11 data communications protocol. Moreover, generating the inhibit communication may be preceded by receiving an identification communication from the portable communications device, and the inhibit communication may be generated for the portable communications device responsive to receiving the identification communication from the portable communications device.

### BRIEF DESCRIPTION OF THE DRAWINGS

FIG. 1 is a block diagram illustrating portable communications devices and local control devices according to embodiments of the present invention.

FIG. 2 is a flow chart illustrating operations of local control devices according to embodiments of the present invention.

FIG. 3 is a flow chart illustrating operations of portable communications devices according to additional embodiments of the present invention.

FIG. 4 is a flow chart illustrating operations of portable communications devices according to still additional embodiments of the present invention.

FIG. 5 is a flow chart illustrating operations of local control devices according to yet additional embodiments of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

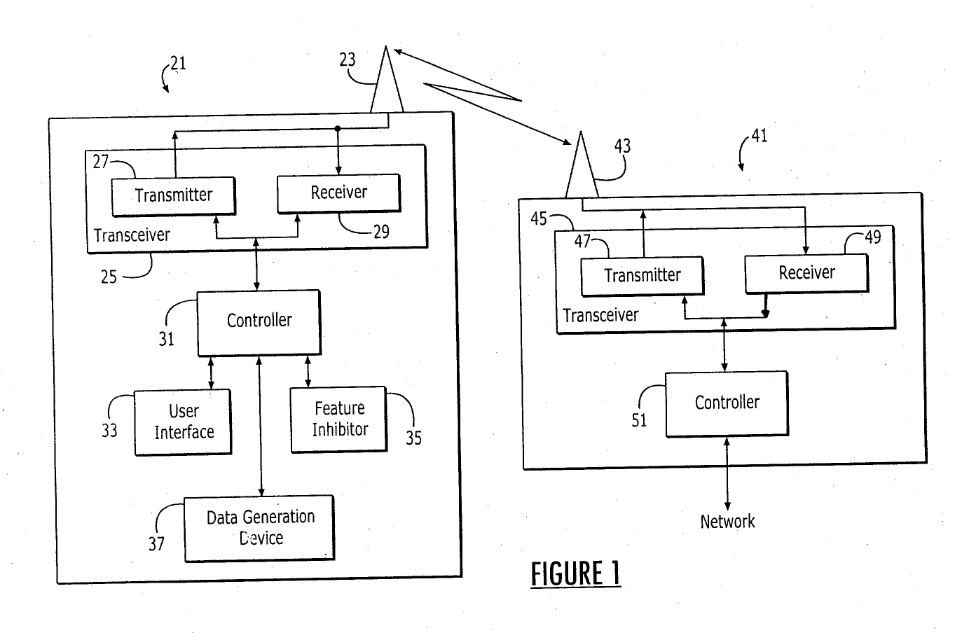

As illustrated in FIG. 1, a portable communications device 21 and a local control device 41 may provide selective inhibition of functionalities of the portable communications device 21 according to embodiments of the present invention. The portable communications device may include an antenna 23; a transceiver 25 including transmitter 27 and receiver 29; a controller 31; a user interface 33; a feature inhibitor 35; and/or a data generation device 37. Accordingly, the transceiver 25 operates under control of controller 31 with the transmitter 27 transmitting data provided by the controller 31 from the antenna 23, and with the receiver 29 providing data received over the antenna 23 to the controller 31.

The user interface 33 is coupled with the controller 31, and the user interface 33 may accept user input from a user and provide data output to a user. The user interface 33, for example, may include one or more input devices such as a microphone, a key pad, and/or a touch sensitive screen used to provide information for transmission from transmitter 27 and/or for control of the portable communications device. The user interface 33 may also include one or more output devices such as a speaker, and/or a display used to provide information to the user.

The data generation device 37 may include one or more data capture devices according to functionalities provided by the personal electronic device. The data generation device 37, for example, may include an image capture device such as a charge coupled device to record still and/or video images and/or a microphone to record audio.

The controller 31 may be configured to support a plurality of functionalities of the portable communications device 21. For example, functionalities supported by the controller 31 may include a plurality of a radiotelephone function, an address book function, a calculator function, a calendar function, a digital camera function, a digital game function, a digital audio recorder function, a digital video recorder function, a digital audio player function, a digital video player function, a pager function, a word processor function, a spreadsheet function, an internet browser function, an e-mail transmitter function, an e-mail receiver function, a digital data transmitter function, and/or a digital image viewer function.

Moreover, cooperation between one or more of these functionalities may be provided. For example, the data generation device 37 may include an image capture device and/or a microphone to record still images, video images, and/or audio, and a data transmitter functionality of the controller 31 may provide wireless transmission of the recorded image, video, and/or audio. Similarly, the user interface 33 may include an image/video screen and/or a speaker allowing reproduction of still images, video, and/or sound, and the controller 31 can be configured to wirelessly receive image data, video data, and/or audio data for reproduction at the user interface 33.

The feature inhibitor 35 may operate in cooperation with the controller 31 to inhibit operation of at least one of the plurality of functionalities of the portable communications device 21 while maintaining operation of at least another of the plurality of functionalities responsive to an inhibit communication received wirelessly at antenna 23 and receiver 29. While the feature inhibitor 35 is shown as a separate block in FIG. 1, the feature inhibitor 35 may be considered a component of controller 31. In an alternative, operations discussed with respect to feature inhibitor 35 may be performed by controller 31.

The transceiver 25 of portable communications device 21 may provide wireless communications according to one or a plurality of communications standards. For example, the transceiver 25 may provide: radiotelephone communications according to an analog standard (such as IS-54), a TDMA standard (such as IS-136 and/or GSM), a CDMA standard, and/or other radiotelephone standards; data communications according to a Wi-Fi standard (such as IEEE 802.11); and/or data communications according to a short range communications standard (such as Bluetooth). Different communications standards may be supported by the transceiver 25 including one transmitter and one receiver. In an alternative, the transceiver 25 may include a plurality of transmitters and/or receivers and/or a plurality of antennas may be provided to support different communications standards.

According to embodiments of the present invention, an inhibit communication can be received wirelessly according to a radiotelephone communications standard, a Wi-Fi standard, and/or a short range communications standard. Responsive to the inhibit communication, one or more functionalities of the portable communications device 21 may be inhibited while maintaining operation of at least another functionality. Responsive to receipt of a wireless inhibit communication, for example, the controller 31 and/or the feature inhibitor 35 may inhibit operation of one or more of a radiotelephone functionality, a digital camera functionality, a digital audio recorder functionality, a digital video recorder functionality, an e-mail transmitter functionality, and/or an internet browser functionality, while operation of at least another functionality is maintained.

In an alternative, responsive to receipt of a wireless inhibit communication, the controller 31 and/or the feature inhibitor 35 may inhibit wireless transmissions while maintaining operation of one or more other functionalities not requiring wireless transmission. In another alternative, responsive to receipt of a wireless inhibit communication, the controller 31 and/or feature inhibitor 35 may inhibit digital recordings of images and/or sound while maintaining operation of at least one functionality not requiring digital recording.

Once a functionality has been selectively inhibited responsive to receipt of an inhibit communication, the controller 31 and/or feature inhibitor 35 may enable operation of the inhibited functionality responsive to an enable communication received wirelessly at the transceiver 25. In an alternative, the controller 31 and/or feature inhibitor 35 may enable operation of the inhibited functionality after passage of a predetermined period of time without receiving a subsequent inhibit communication.

The local control device 41 may include an antenna 43; a transceiver 45 including transmitter 47 and receiver 49; and a controller 51. According to embodiments of the present invention, the local control device may be a wireless access point for a data network operating according to a short range data communications protocol such as Bluetooth or IEEE 802.11. For example, the controller 51 may control operations of transceiver 45 and process data received by and transmitted from transceiver 45 so that the local control device 41 may provide a wireless interface between a network and portable communications devices within range of the local control device 41. Because the local control device 41 may operate over a short range, the local control device 41 may only support communications with portable communications devices that are relatively close such as in a same building, on a same floor, or in a same room.

In addition, the local control device 41 may transmit inhibit communications used to inhibit functionalities of portable communications devices within range of the local control device 41. According to some embodiments of the present invention, the local control device may periodically transmit an inhibit communication for reception by all compatible portable communications devices within range, and the inhibit communication may be tailored to the location in which the local control device 41 is located. For example, the local control device may be located in a theater or on an airplane with a range to cover the theater or airplane, and the local control device may be configured to periodically transmit an inhibit communication to inhibit radiotelephone operations of all compatible electronic devices within the theater or airplane. Accordingly, selected operations may be inhibited in a confined area without requiring two way communications between the local control device 41 and the portable communications device 21.

Moreover, the portable communications device 21 may enable the inhibited functionality after passage of a predetermined period of time without receiving the periodic inhibit communication. Accordingly, the inhibited functionality may be enabled automatically once the portable communications device 21 is outside a range of the local control device 41 and/or the once the local control device 41 ceases transmission of the periodic inhibit communication. In other words, the inhibited functionality can be restored either because the local control device 41 permits the functionality by ceasing transmission of the inhibit communication (such as during an intermission at a theater) or because the portable communications device 21 is no longer within range of the local control device 41 (such as when the user takes the electronic device outside the theater).

According to additional embodiments, the electronic device 21 may announce its presence to the local control device 41 before the local control device 41 generates and transmits an inhibit communication specific to the electronic device 21. For example, upon detecting the presence of a local control device, the portable communications device 21 may transmit an identification communication providing an identifier for the electronic device 21 and providing identification of the functionalities provided by the electronic device 21. The local control device 41 can then respond with an inhibit communication specific to the electronic device 21 so that functionalities to be inhibited can be determined on a case by case basis. For example, different electronic devices may be given different authorizations so that the local control device may inhibit a particular functionality in some devices and allow the same functionality in other devices. Electronic devices assigned to emergency responders (such as policemen, firemen, and/or emergency medical personnel), for example, may be identified so that all functionalities are maintained, while electronic devices assigned to civilians may be subjected to inhibited function.

As discussed above, the local control device 41 may provide a wireless interface between a portable communications device 21 and a network and a source of inhibit control for functionalities for portable communications devices within range thereof. In an, alternative, the local control device may not provide a network interface. According to embodiments of the present invention, a local control device may provide the function of transmitting inhibit communications without otherwise providing an interface to a network.

By using a short range communication protocol for communication between the local control device 41 and the portable communications device 21, the area over which the local control device can inhibit functionality of portable communications devices may be limited to the range of communications of the short range protocol. Accordingly, the use of a short range protocol may provide the advantage that it is specific to a relatively small location within transmission range of the local control device 41. The range may be further limited by controlling a transmission power of the local control device 41, and/or by shielding an area within which the local control device 41 is to be used.

According to additional embodiments of the present invention, the local control device 41 may be a radiotelephone base station for a cellular radiotelephone communications system according to a standard such as IS-136, GSM, and/or CDMA, or a base station for a trunked radio communications system. Here, selected functionalities may be inhibited for all electronic devices communicating with the base station in a cell serviced by the base station. A particular base station, for example, may provide service over a cell on a military installation wherein photographs are prohibited. Accordingly, an inhibit communication from the base station may instruct electronic devices in range thereof to inhibit digital camera functionalities.

In an alternative, when inhibit communications are transmitted by a local control device 41 such as a radiotelephone base station covering a relatively large area, positioning technologies may be used to selectively transmit inhibit communications to electronic devices located within particular portions of a cell covered by the base station. The portable communications device 21, for example, may include a positioning system, such as GPS (global positioning system) or LORAN, allowing the portable communications device 21 to determine its position, and the position can be transmitted to the base station acting as local control device 41. In an alternative, a position of the portable communications device 21 can be determined using triangulation from a plurality of base stations. Once the position of the portable communications device 21 is provided to or determined by the base station, an inhibit communication can be transmitted to the particular portable communications device 21 if it is located in an area for which function inhibition is desired.

For example, when the portable communications device 21 enters a cell covered by a base station acting as local control device 41, the portable communications device 21 may identify itself to the base station using an identification communication. If the electronic device includes a positioning system (such as GPS or LORAN), the identification communication may include the position of the electronic device as determined by the positioning system and an identification of the electronic device, such as a mobile identification number (MIN). If the portable communications device 21 does not include a positioning system, the identification communication may include an identification of the electronic device such as an MIN, and the base station can use the identification communication to triangulate a position of the electronic device in coordination with other base stations. The base station can then use the location and identification of the portable communications device 21 to send an inhibit communication to the particular portable communications device 21 if the particular portable communications device is located in an area where some functionality should be inhibited, such as on a military base.

By sending periodic identification communications from the portable communications device 21 to the base station, the base station can transmit inhibit communications and enable communications as the electronic device moves into and out of areas in which particular functionalities should be inhibited. Moreover, different functionalities may be inhibited in different areas covered by the same base station. For example, digital camera and video functionalities may be inhibited in one area, and radiotelephone communications may be inhibited in another area.

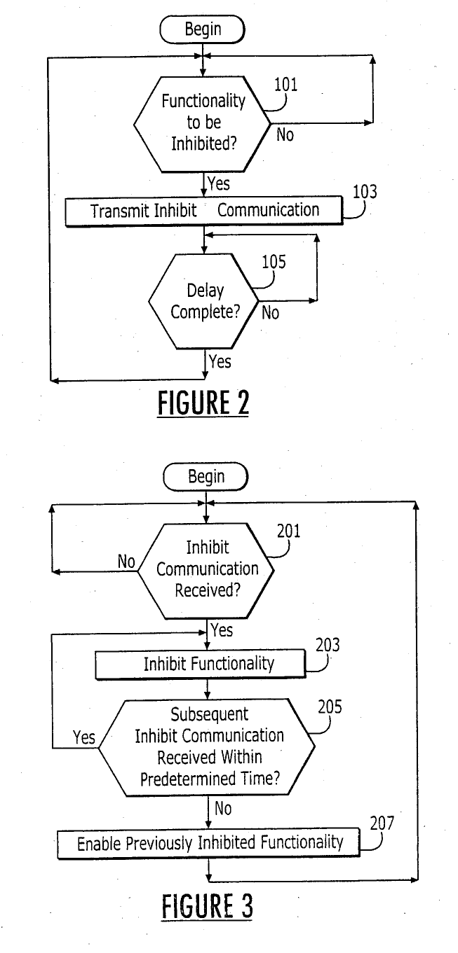

Operations of portable communications devices and local control devices according to embodiments of the present invention are illustrated in FIGS. 2 and 3. As shown in FIG. 2, a local control device may transmit periodic inhibit communications as long as a particular functionality of portable communications devices within range of the local control device should be inhibited. More particularly, a local control device may wait at block 101 until a particular functionality (or functionalities) of portable communications devices should be inhibited. Once it is determined that a functionality (or functionalities) should be inhibited, an inhibition communication can be transmitted at block 103.

A predetermined delay can be imposed at block 105 before the next inhibit communication is transmitted. More particularly, once a predetermined delay has passed at block 105, the local control device can determine at block 101 if the functionality should still be inhibited. If so, the inhibit communication can be transmitted again at block 103. If not, the local control device can wait at block 101 until the same or a different functionality should be inhibited.

The inhibit communication transmitted at block 103 may apply to all portable communications devices within range of the local control device so that the same functionality is inhibited at all portable communications devices within range of the local control device. In an alternative, the inhibit communication may be directed to one or a group of portable communications devices for which a particular functionality should be inhibited. For example, the inhibit communication may include an identification of the particular functionality to be inhibited and/or an identification of the particular portable communications device(s) for which the particular functionality should be inhibited.

As discussed above, the local control device may operate within a relatively confined environment such as a theater or an airplane. In a theater, a radiotelephone functionality may be inhibited for portable communications devices during performances to reduce unnecessary noise. In an airplane, a radiotelephone functionality may be inhibited during take-off and landing to reduce interference with navigational equipment. In each of these examples, the transmit inhibit communication can be transmitted periodically so that radiotelephone functionality is inhibited for all portable communications devices whenever present within the theater or airplane. Stated in other words, the block 101 may be eliminated so that the periodic transmissions are always transmitted.

In an alternative, the local control device may periodically transmit an inhibit communication when a functionality is to be inhibited and cease periodic transmission of the inhibit communication when the functionality is allowed. In a theater, the inhibit communication may be periodically transmitted at block 103 during a performance to inhibit radiotelephone functionality for portable communications devices in the theater, but periodic transmission of inhibit communications may cease at block 101 during intermissions to allow radiotelephone functionality. In an airplane, the inhibit communication may be periodically transmitted at block 103 during take-off and landing, but periodic transmission of inhibit communications may cease at block 101 while the airplane is cruising and/or waiting at a gate.

Operations of portable communications devices according to embodiments of the present invention are illustrated in FIG. 3. The portable communications device waits at block 201 until an inhibit communication is received from a local control device. Once an inhibit communication is received at block 201 from a local control device, the portable communications device operates to inhibit a functionality thereof at block 203 as instructed in the inhibit communication. For example, the portable communications device may inhibit one or more functionalities such as a radiotelephone functionality, a digital camera functionality, a digital audio recorder functionality, a digital video recorder functionality, an e-mail transmitter functionality, and/or an internet browser functionality.

Where a periodic inhibit communication is transmitted by a local control device, the portable communications device may wait for receipt of a next inhibit communication at block 205. If a next inhibit communication is received within a predetermined time period (equal to or greater than a period of the periodic transmission from the local control device) at block 205, the inhibited functionality may remain inhibited in the loop of blocks 203 and 205. If a next inhibit communication is not received within the predetermined time period (equal to or greater than a period of the periodic transmission from the local control device) at block 205, previously inhibited functionality may be enabled at block 207 until another inhibit communication is received at block 201. On receipt of an inhibit communication, a portable communications device may inhibit a particular functionality designated in the inhibit communication either until the portable communications device moves out of range of the local control device transmitting periodic inhibit communications and/or until the local control device ceases transmission of the periodic inhibit communications.

An inhibit communication received at block 201 may be a general communication intended for all portable communications devices within range of receiving the inhibit communication, in which case, the portable communications device may only identify the functionally to be inhibited responsive to the inhibit communication. The inhibit communication may include information identifying a particular functionality to be inhibited by all portable communications devices receiving the inhibit communication.

In an alternative, an inhibit communication received at block 201 may be intended for a specific portable communications device or category of devices. Accordingly, the inhibit communication may include an identification of the portable communications device or of a category of devices. Accordingly, the operation of receiving an inhibit communication at block 201 may include determining if the inhibit communication applies to the portable communications device receiving the communication and, if so, the functionality to be inhibited.

Responsive to receiving an inhibit communication intended for the portable communications device, the portable communications device may inhibit operation of at least one of a plurality of functionalities supported by the portable communications device while maintaining operation of at least another of the plurality of functionalities supported by the portable communications device. More particularly, the portable communications device may inhibit a particular functionality identified by the inhibit communication. For example, the inhibit communication may indicate inhibition of at least one of a radiotelephone functionality, a digital camera functionality, a digital audio recorder functionality, a digital video recorder functionality, an e-mail transmitter functionality, and/or an internet browser functionality. In an alternative, the inhibit communication may indicate inhibition of wireless transmissions.

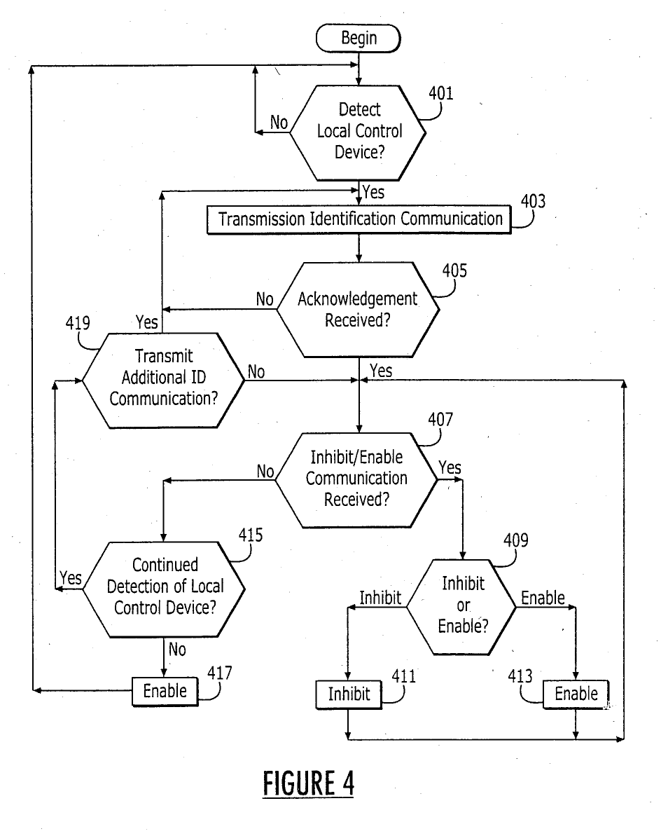

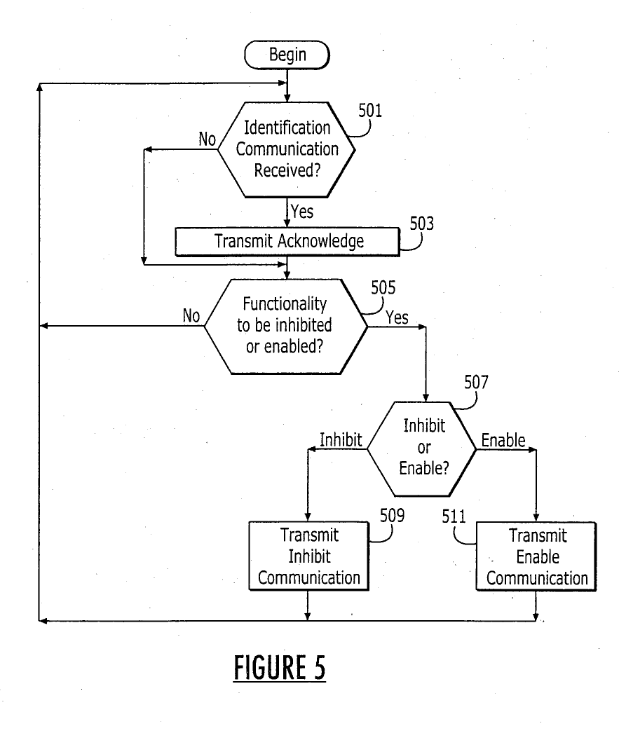

Operations of portable communications devices and local control devices according to additional embodiments of the present invention are illustrated in FIGS. 4 and 5. As illustrated in FIG. 4, a portable communications device may monitor one or more control channels to determine if a local control device is within range at block 401. Once a local control device is detected at block 401, the portable communications device may transmit an identification communication at block 403. The identification communication may include a unique identification of the portable communications device, and the identification communication may also include an identification of functionalities supported by the portable communications device.

On receipt of the identification communication, the local control device may transmit an acknowledgement, and the portable communications device may retransmit the identification communication until an acknowledgement is received at block 405. Once the identification communication has been received by the local control device, the local control device can determine if one or more functionalities of the portable communications device should be inhibited. Accordingly, the portable communications device may determine if either an inhibit or an enable communication for the portable communications device is received at block 407. Moreover, an initial inhibit communication may be received as a part of the acknowledgement or a separate inhibit communication may be transmitted. More particularly, any acknowledgement communication, inhibit communication, and/or enable communication for the portable communications device may include an identification of the portable communications device as provided in the identification communication.

If an inhibit or an enable communication for the portable communications device is received at block 407, the particular functionality to be inhibited or enabled can be determined at block 409, and the particular functionality either inhibited at block 411 or enabled at block 413. Once the particular functionality has been either inhibited or enabled at block 411 or 413, the portable communications device can monitor for another inhibit or enable communication at block 407.

While no inhibit or enable communication is received at block 407 and the portable communications device continues to detect the local control device at block 415, the portable communications device may monitor for a new inhibit or enable communication addressed to the portable communications device and for continued detection of the local control device. If another inhibit or enable communication for the portable communications device is received at block 407, the indicated functionality is either inhibited or enabled at blocks 409, 411, and/or 413. If the portable communications device no longer detects the local control device at block 415, the portable communications device may enable all inhibited functionalities at block 417 and await detection of another or the same local control device at block 401.

While no inhibit or enable communication is received at block 407 and the portable communications device continues to detect the local control device at block 415, the portable communications device may determine at block 419 if an additional identification should be transmitted at block 419. If an additional identification communication should be transmitted, the additional identification communication can be transmitted at block 403, and retransmitted until an acknowledgement is received at block 405. The portable communications device can then continue to monitor for inhibit/enable communications and for continued detection of the local control device at blocks 407 and 415. Otherwise, monitoring for inhibit/enable communications and for continued detection of the local control device can be continued at blocks 407 and 415 without transmitting an additional identification communication.

Additional identification communications may be transmitted by the portable communications device at block 403 periodically, for example, to inform the local control device of the continued presence of the portable communications device. Accordingly, the block 419 may determine that it is time to transmit an additional identification communication at predetermined time intervals. In an alternative or in addition, the identification communications may include information identifying a position of the portable communications device used by the local control device to determine what if any functionality of the portable communications device should be inhibited.

The portable communications device, for example, may include a global positioning system (GPS) allowing the portable communications device to determine its position, and this positioning information can be provided in the identification communications transmitted at block 403. When a base station of a radiotelephone communications system is acting as a local control device, a cell covered by the base station may be relatively large. Accordingly, inhibit communications may be transmitted to portable communications devices based on location within the cell. The portable communications device may thus transmit identification communications on detection of a change in position instead of or in addition to periodically transmitting identification communications after passage of a predetermined time interval. Accordingly, the local control device can track a position of the portable communications device and generate inhibit and/or enable communications for the portable communications device based on a location of the portable communications device.

In an alternative, periodic identification transmissions from the portable communications device may be used by the local control device to determine a position of the portable communications device. For example, when a base station of a radiotelephone system is used as a local control device, a plurality of base stations in the system may triangulate a position of the portable communications device using the periodic identification communications transmitted from the portable communications device at predetermined intervals of time.

Operations of a local control device according to embodiments of the present invention are illustrated in FIG. 5. As discussed above, a portable communications device may transmit an identification communication upon detecting the presence of a local control device. The local control device, for example, may transmit its identification over a control channel within an area covered by the local control device. When implemented as a network node according to a short range communications protocol, the control channel may be transmitted within a confined area such as within a building, within a floor, within a room, within a theater, and/or within an airplane. When implemented as a base station in a cellular communications system, the control channel may be transmitted over the cell covered by the base station acting as a local control device.

In response to receiving a control channel from the local control device, the portable communications device may transmit an identification communication to the local control device. When a identification communication is received from a portable communications device at block 501, the local control device may transmit an acknowledge communication to the portable communications device at block 503. At block 505, a determination can be made whether any functionalities of the portable communications device should be inhibited or enabled. If a functionality should be enabled or inhibited at block 505, the particular functionality to be enabled or disabled can be determined at block 507 and either an inhibit communication or an enable communication can be transmitted at block 509 or 511. Once the inhibit or enable communication has been transmitted, the local control device can monitor for additional identification communications at block 501 and monitor whether any functionalities should be inhibited or enabled at block 505.

Once an initial identification communication has been received from a portable communications device, the local control device may monitor for additional identification communications from the portable communications device at block 501 and/or make on going determinations as to whether functionalities for the portable communications device should be inhibited or enabled at block 505. As discussed above, identification communications from the portable communications device may include information identifying a position of the portable communications device (such as GPS information) and/or the identification communication may be used by the local control device to determine a position of the portable communications device (such as through triangulation).

Accordingly, the local control device can determine functionalities to be inhibited and/or enabled at blocks 505 and 507 based on changing positions of the portable communications device. For example, the local control device may be implemented as a base station of a cellular radiotelephone system, and the local control device may inhibit a particular functionality while within one region of a cell covered by the base station, and the same functionality may be enabled while within a second region of the cell covered by the base station.

The local control device can also determine functionalities to be inhibited and/or enabled at blocks 505 and 507 based on factors other than position. The local control device, for example, may provide short range communications in a relatively confined environment, such as in a theater or an airplane. Accordingly, an inhibit communication may be transmitted to inhibit a functionality such as a radiotelephone functionality during a performance or during take-off/landing. An enable communication can then be transmitted to enable a functionality such as a radiotelephone functionality during an intermission in a theater or while at a gate or cruising in an airplane. Moreover, an acknowledge communication may be transmitted as part of an inhibit or enable communication. Similarly, an inhibit or enable communication may be transmitted as a part of an acknowledge communication.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed:

1. A portable communications device comprising:
a transceiver configured to receive wireless communications; and
a controller coupled to the transceiver,
wherein the controller is configured to process communications received by the transceiver,
wherein the controller is configured to provide a plurality of functionalities of the portable communications device, and
wherein the controller is configured to selectively inhibit operation of at least one of the plurality of functionalities while maintaining operation of at least another of the plurality of functionalities responsive to an inhibit communication received wirelessly at the transceiver.

2. A portable communications device according to claim 1 wherein the plurality of functionalities of the portable communications device include at least two of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer.

3. A portable communications device according to claim 1 wherein the plurality of functionalities of the portable communications device includes a radiotelephone and at least one of an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein operation of the radiotelephone functionality is inhibited responsive to the inhibit communication while operation of at least another of the functionalities is maintained.

4. A portable communications device according to claim 1 wherein the plurality of functionalities of the portable communications device includes a digital camera and at least one of a radiotelephone, an address book, a calculator, a calendar, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein operation of the digital camera functionality is inhibited responsive to the inhibit communication while operation of at least another of the functionalities is maintained.

5. A portable communications device according to claim 1 wherein the plurality of functionalities of the portable communications device includes a digital audio recorder and at least one of a radiotelephone, an address book, a calculator, a calendar, a digital camera, a digital game, a digital video recorder, a digital audio player, a digital video player, a pager, a word processor, a spreadsheet, an internet browser, an e-mail transmitter, an e-mail receiver, a digital data transmitter, and/or a digital image viewer, wherein operation of the digital audio recorder functionality is inhibited responsive to the inhibit communication while operation of at least another of the functionalities is maintained.

6. A portable communications device according to claim 1 wherein the plurality of functionalities of the portable communications device includes a digital video recorder and at least one of a radiotelephone, an address book, a calculator, a calendar, a digital camera, a digital game, a digital audio recorder, a digital audio player, a digital video player, a pager, a word processor, a spreadsheet, an internet browser, an e-mail transmitter, an e-mail receiver, a digital data transmitter, and/or a digital image viewer, wherein operation of the digital video recorder functionality is inhibited responsive to the inhibit communication while operation of at least another of the functionalities is maintained.

7. A portable communications device according to claim 1 wherein the plurality of functionalities of the portable communications device includes an e-mail transmitter and at least one of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail receiver, a digital data transmitter, and/or a digital image viewer, wherein operation of the e-mail transmitter functionality is inhibited responsive to the inhibit communication while operation of at least another of the functionalities is maintained.

8. A portable communications device according to claim 1 wherein the plurality of functionalities of the portable communications device includes an internet browser and at least one of a radiotelephone, an address book, a calculator, a calendar, a digital camera, a digital game, a digital audio recorder, a digital video recorder, a digital audio player, a digital video player, a pager, a word processor, a spreadsheet, an e-mail transmitter, an e-mail receiver, a digital data transmitter, and/or a digital image viewer, wherein operation of the internet browser functionality is inhibited responsive to the inhibit communication while operation of at least another of the functionalities is maintained.

9. A portable communications device according to claim 1 wherein the controller is configured to selectively inhibit wireless transmissions while maintaining operation of at least one functionality not requiring transmission responsive to the inhibit communication.

10. A portable communications device according to claim 1 wherein the controller is configured to selectively inhibit digital recording of images and/or sound while maintaining operation of at least one functionality not requiring digital recording responsive to the inhibit communication.

11. A portable communications device according to claim 1 wherein after selectively inhibiting operation of the at least one of the plurality of functionalities, the controller is further configured to enable operation of the at least one of the plurality of functionalities responsive to an enable communication received wirelessly at the transceiver.

12. A portable communications device according to claim 1 wherein after selectively inhibiting operation of the at least one of the plurality of functionalities, the controller is further configured to enable operation of at least one of the plurality of functionalities after passage of a predetermined period of time without receiving a subsequent inhibit communication.

13. A portable communications device according to claim 1 wherein the inhibit communication is received wirelessly at the transceiver according to a short range data communication protocol.

14. A portable communications device according to claim 13 wherein the short range data communications protocol comprises a Bluetooth data communications protocol.

15. A portable communications device according to claim 13 wherein the short range data communications protocol comprises an IEEE 802.11 data communications protocol.

16. A local control device comprising:
a transmitter that transmits wireless communications to portable communications devices; and
a controller coupled to the transmitter, wherein the controller is configured to process communications transmitted from the transmitter, wherein the controller is configured to generate an inhibit communication for a portable communications device providing a plurality of functionalities instructing the portable communications device to selectively inhibit operation of at least one of the plurality of functionalities while maintaining operation of at least another of the plurality of functionalities, wherein the inhibit communication is transmitted by the transmitter.

17. A local control device according to claim 16 wherein the plurality of functionalities of the portable communications device include at least two of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer.

18. A local control device according to claim 16 wherein the plurality of functionalities of the portable communications device includes a radiotelephone and at least one of an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein the inhibit communication instructs the portable communications device to inhibit operation of the radiotelephone functionality while maintaining operation of at least another of the functionalities.

19. A local control device according to claim 16 wherein the plurality of functionalities of the portable communications device includes a digital camera and at least one of a radiotelephone, an address book, a calculator, a calendar, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein the inhibit communication instructs the portable communications device to inhibit operation of the digital camera functionality while maintaining operation of at least another of the functionalities.

20. A local control device according to claim 16 wherein the plurality of functionalities of the portable communications device includes a digital audio recorder and at least one of a radiotelephone, an address book, a calculator, a calendar, a digital camera, a digital game, a digital video recorder, a digital audio player, a digital video player, a pager, a word processor, a spreadsheet, an internet browser, an e-mail transmitter, an e-mail receiver, a digital data transmitter, and/or a digital image viewer, wherein the inhibit communication instructs the portable communications device to inhibit operation of the digital audio recorder functionality while maintaining operation of at least another of the functionalities.

21. A local control device according to claim 16 wherein the plurality of functionalities of the portable communications device includes a digital video recorder and at least one of a radiotelephone, an address book, a calculator, a calendar, a digital camera, a digital game, a digital audio recorder, a digital audio player, a digital video player, a pager, a word processor, a spreadsheet, an internet browser, an e-mail transmitter, an e-mail receiver, a digital data transmitter, and/or a digital image viewer, wherein the inhibit communication instructs the portable communications device to inhibit operation of the digital video recorder functionality while maintaining operation of at least another of the functionalities.

22. A local control device according to claim 16 wherein the plurality of functionalities of the portable communications device includes an e-mail transmitter and at least one of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail receiver, a digital data transmitter, and/or a digital image viewer, wherein the inhibit communication instructs the portable communications device to inhibit operation of the e-mail transmitter functionality while maintaining operation of at least another of the functionalities.

23. A local control device according to claim 16 wherein the plurality of functionalities of the portable communications device includes an internet browser and at least one of a radiotelephone, an address book, a calculator, a calendar, a digital camera, a digital game, a digital audio recorder, a digital video recorder, a digital audio player, a digital video player, a pager, a word processor, a spreadsheet, an e-mail transmitter, an e-mail receiver, a digital data transmitter, and/or a digital image viewer, wherein the inhibit communication instructs the portable communications device to inhibit operation of the internet browser functionality while maintaining operation of at least another of the functionalities.

24. A local control device according to claim 16 wherein the inhibit communication instructs the portable communications device to selectively inhibit wireless transmissions while maintaining operation of at least one functionality not requiring transmission.

25. A local control device according to claim 16 wherein the inhibit communication instructs the portable communications device to selectively inhibit digital recording of images and/or sound while maintaining operation of at least one functionality not requiring digital recording.

26. A local control device according to claim 16 wherein after transmitting the inhibit communication, the controller generates an enable communication instructing the portable communications device to enable operation of the at least one of the plurality of functionalities previously inhibited, wherein the enable communication is transmitted from the transmitter.

27. A local control device according to claim 16 wherein the inhibit communication is transmitted wirelessly from the transmitter according to a short range data communication protocol.

28. A local control device according to claim 27 wherein the short range data communications protocol comprises a Bluetooth data communications protocol.

29. A local control device according to claim 27 wherein the short range data communications protocol comprises an IEEE 802.11 data communications protocol.

30. A local control device according to claim 16 further comprising:
a receiver coupled to the controller wherein the receiver receives an identification communication from the portable communications device and wherein the controller generates the inhibit communication for the portable communications device responsive to receiving the identification communication from the portable communications device.

31. A method of operating a portable communications device providing a plurality of functionalities, the method comprising:
wirelessly receiving an inhibit communication; and
selectively inhibiting operation of at least one of the plurality of functionalities while maintaining operation of at least another of the plurality of functionalities responsive to the inhibit communication.

32. A method according to claim 31 wherein the plurality of functionalities of the portable communications device include at least two of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer.

33. A method according to claim 31 wherein the plurality of functionalities of the portable communications device includes a radiotelephone and at least one of an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein selectively inhibiting operation of at least one of the plurality of functionalities comprises inhibiting operation of the radiotelephone functionality responsive to the inhibit communication while operation of at least another of the functionalities is maintained.

34. A method according to claim 31 wherein the plurality of functionalities of the portable communications device includes a digital camera and at least one of a radiotelephone, an address book, a calculator, a calendar, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein selectively inhibiting operation of at least one of the plurality of functionalities comprises inhibiting operation of the digital camera functionality responsive to the inhibit communication while operation of at least another of the functionalities is maintained.

35. A method according to claim 31 wherein the plurality of functionalities of the portable communications device includes a digital audio recorder and at least one of a radiotelephone, an address book, a calculator, a calendar, a digital camera, a digital game, a digital video recorder, a digital audio player, a digital video player, a pager, a word processor, a spreadsheet, an internet browser, an e-mail transmitter, an e-mail receiver, a digital data transmitter, and/or a digital image viewer, wherein selectively inhibiting operation of at least one of the plurality of functionalities comprises inhibiting operation of the digital audio recorder functionality responsive to the inhibit communication while operation of at least another of the functionalities is maintained.

36. A method according to claim 31 wherein the plurality of functionalities of the portable communications device includes a digital video recorder and at least one of a radiotelephone, an address book, a calculator, a calendar, a digital camera, a digital game, a digital audio recorder, a digital audio player, a digital video player, a pager, a word processor, a spreadsheet, an internet browser, an e-mail transmitter, an e-mail receiver, a digital data transmitter, and/or a digital image viewer, wherein selectively inhibiting operation of at least one of the plurality of functionalities comprises inhibiting operation of the digital video recorder functionality responsive to the inhibit communication while operation of at least another of the functionalities is maintained.

37. A method according to claim 31 wherein the plurality of functionalities of the portable communications device includes an e-mail transmitter and at least one of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail receiver, a digital data transmitter, and/or a digital image viewer, wherein selectively inhibiting operation of at least one of the plurality of functionalities comprises inhibiting operation of the e-mail transmitter functionality responsive to the inhibit communication while operation of at least another of the functionalities is maintained.

38. A method according to claim 31 wherein the plurality of functionalities of the portable communications device includes an internet browser and at least one of a radiotelephone, an address book, a calculator, a calendar, a digital camera, a digital game, a digital audio recorder, a digital video recorder, a digital audio player, a digital video player, a pager, a word processor, a spreadsheet, an e-mail transmitter, an e-mail receiver, a digital data transmitter, and/or a digital image viewer, wherein selectively inhibiting operation of at least one of the plurality of functionalities comprises inhibiting operation of the internet browser functionality responsive to the inhibit communication while operation of at least another of the functionalities is maintained.

39. A method according to claim 31 wherein selectively inhibiting operation of at least one of the plurality of functionalities comprises selectively inhibiting wireless transmissions while maintaining operation of at least one functionality not requiring wireless transmission responsive to the inhibit communication.

40. A method according to claim 31 wherein selectively inhibiting operation of at least one of the plurality of functionalities comprises selectively inhibiting digital recording of images and/or sound while maintaining operation of at least one functionality not requiring digital recording responsive to the inhibit communication.

41. A method according to claim 31 further comprising:
after selectively inhibiting operation of the at least one of the plurality of functionalities, wirelessly receiving an enable communication; and
enabling operation of the at least one of the plurality of functionalities responsive to receiving the enable communication.

42. A method according to claim 31 further comprising:
after selectively inhibiting operation of the at least one of the plurality of functionalities for a predetermined period of time without receiving a subsequent inhibit communication, enabling operation of the at least one of the plurality of functionalities.

43. A method according to claim 31 wherein the inhibit communication is received wirelessly according to a short range data communication protocol.

44. A method according to claim 43 wherein the short range data communications protocol comprises a Bluetooth data communications protocol.

45. A method according to claim 43 wherein the short range data communications protocol comprises an IEEE 802.11 data communications protocol.

46. A method of controlling operations of portable communications devices in a local area, the method comprising:
generating an inhibit communication for a portable communications device providing a plurality of functionalities wherein the inhibit communication includes instruction for the portable communications device to selectively inhibit operation of at least one of the plurality of functionalities while maintaining operation of at least another of the plurality of functionalities; and
wirelessly transmitting the inhibit communication to the portable communications device.

47. A method according to claim 46 wherein the plurality of functionalities of the portable communications device include at least two of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer.

48. A method according to claim 46 wherein the plurality of functionalities of the portable communications device includes a radiotelephone and at least one of an address book, a calculator, a calendar, a digital camera, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein the inhibit communication includes instruction for the portable communications device to inhibit operation of the radiotelephone functionality while maintaining operation of at least another of the functionalities.

49. A method according to claim 46 wherein the plurality of functionalities of the portable communications device includes a digital camera and at least one of a radiotelephone, an address book, a calculator, a calendar, a digital game, a digital audio recorder, a digital video recorder, a digital audio player, a digital video player, a pager, a word processor, a spreadsheet, an internet browser, an e-mail transmitter, an e-mail receiver, a digital data transmitter, and/or a digital image viewer, wherein the inhibit communication includes instruction for the portable communications device to inhibit operation of the digital camera functionality while maintaining operation of at least another of the functionalities.

50. A method according to claim 46 wherein the plurality of functionalities of the portable communications device includes a digital audio recorder and at least one of a radiotelephone, an address book, a calculator, a calendar, a digital camera, a digital game, a digital video recorder, a digital audio player, a digital video player, a pager, a word processor, a spreadsheet, an internet browser, an e-mail transmitter, an e-mail receiver, a digital data transmitter, and/or a digital image viewer, wherein the inhibit communication includes instruction for the portable communications device to inhibit operation of the digital audio recorder functionality while maintaining operation of at least another of the functionalities.

51. A method according to claim 46 wherein the plurality of functionalities of the portable communications device includes a digital video recorder and at least one of a radiotelephone, an address book, a calculator, a calendar, a digital camera, a digital game, a digital audio recorder, a digital audio player, a digital video player, a pager, a word processor, a spreadsheet, an internet browser, an e-mail transmitter, an e-mail receiver, a digital data transmitter, and/or a digital image viewer, wherein the inhibit communication includes instruction for the portable communications device to inhibit operation of the digital video recorder functionality while maintaining operation of at least another of the functionalities.

52. A method according to claim 46 wherein the plurality of functionalities of the portable communications device includes an e-mail transmitter and at least one of a radiotelephone, an address book, a calculator, a calendar, a digital camera, a digital game, a digital audio recorder, a digital video recorder, a digital audio player, a digital video player, a pager, a word processor, a spreadsheet, an internet browser, an e-mail receiver, a digital data transmitter, and/or a digital image viewer, wherein the inhibit communication includes instruction for the portable communications device to inhibit operation of the e-mail transmitter functionality while maintaining operation of at least another of the functionalities.

53. A method according to claim 46 wherein the plurality of functionalities of the portable communications device includes an internet browser and at least one of a radiotelephone, an address book, a calculator, a calendar, a digital camera, a digital game, a digital audio recorder, a digital video recorder, a digital audio player, a digital video player, a pager, a word processor, a spreadsheet, an e-mail transmitter, an e-mail receiver, a digital data transmitter, and/or a digital image viewer, wherein the inhibit communication includes instruction for the portable communications device to inhibit operation of the internet browser functionality while maintaining operation of at least another of the functionalities.

54. A method according to claim 46 wherein the inhibit communication includes instruction for the portable communications device to selectively inhibit wireless transmissions while maintaining operation of at least one functionality not requiring transmission.

55. A method according to claim 46 wherein the inhibit communication includes instruction for the portable communications device to selectively inhibit digital recording of images and/or sound while maintaining operation of at least one functionality not requiring digital recording.

56. A method according to claim 46 further comprising:
after transmitting the inhibit communication, generating an enable communication instructing the portable communications device to enable operation of the at least one of the plurality of functionalities previously inhibited; and
transmitting the enable communication to the portable communications device.

57. A method according to claim 46 wherein the inhibit communication is transmitted wirelessly according to a short range data communication protocol.

58. A method according to claim 57 wherein the short range data communications protocol comprises a Bluetooth data communications protocol.

59. A method according to claim 57 wherein the short range data communications protocol comprises an IEEE 802.11 data communications protocol.

60. A method according to claim 46 wherein generating the inhibit communication is preceded by:
receiving an identification communication from the portable communications device and wherein the inhibit communication is generated for the portable communications device responsive to receiving the identification communication from the portable communications device.
